(19) United States
(12) Patent Application Publication
(10) Pub. No.: US 2018/0295810 A1
(43) Pub. Date: Oct. 18, 2018

(54) Animal Bathing Assembly

(71) Applicants: Michelle Zabell, Vancouver, WA (US); Ari Zabell, Vancouver, WA (US)

(72) Inventors: Michelle Zabell, Vancouver, WA (US); Ari Zabell, Vancouver, WA (US)

(21) Appl. No.: 15/485,714

(22) Filed: Apr. 12, 2017

(51) Int. Cl. A01K 13/00; A01K 15/04

(52) U.S. Cl. CPC A01K 13/001; A01K 15/04

(57) ABSTRACT

An animal bathing assembly includes a box that may have an animal positioned therein. The box is selectively filled with a fluid thereby facilitating the animal to be bathed in the fluid. A spigot is coupled to the box to selectively drain the fluid from the box. A lid is selectively positioned on the box. The lid has a first opening to have a head of the animal extending therethrough when the lid is positioned on the box. The lid has a second opening to have the fluid poured therethrough when the lid is positioned on the box. A pair of locks is provided and each of the locks is hingedly coupled to the box. Each of the locks engages the lid to removably retain the lid on the box. In this way the lid inhibits the animal from escaping the box.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to bathing devices and more particularly pertains to a new bathing device for restraining an animal thereby facilitating the animal to be bathed.

### BRIEF SUMMARY OF THE INVENTION

An embodiment of the disclosure meets the needs presented above by generally comprising a box that may have an animal positioned therein. The box is selectively filled with a fluid thereby facilitating the animal to be bathed in the fluid. A spigot is coupled to the box to selectively drain the fluid from the box. A lid is selectively positioned on the box. The lid has a first opening to have a head of the animal extending therethrough when the lid is positioned on the box. The lid has a second opening to have the fluid poured therethrough when the lid is positioned on the box. A pair of locks is provided and each of the locks is hingedly coupled to the box. Each of the locks engages the lid to removably retain the lid on the box. In this way the lid inhibits the animal from escaping the box.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an animal bathing assembly according to an embodiment of the disclosure.

FIG. 2 is a front view of an embodiment of the disclosure.

FIG. 3 is an exploded perspective view of an embodiment of the disclosure.

FIG. 4 is a top view of a box of an embodiment of the disclosure. FIG. 5 is a perspective in-use view of an embodiment of the disclosure.

### DETAILED DESCRIPTION OF THE INVENTION

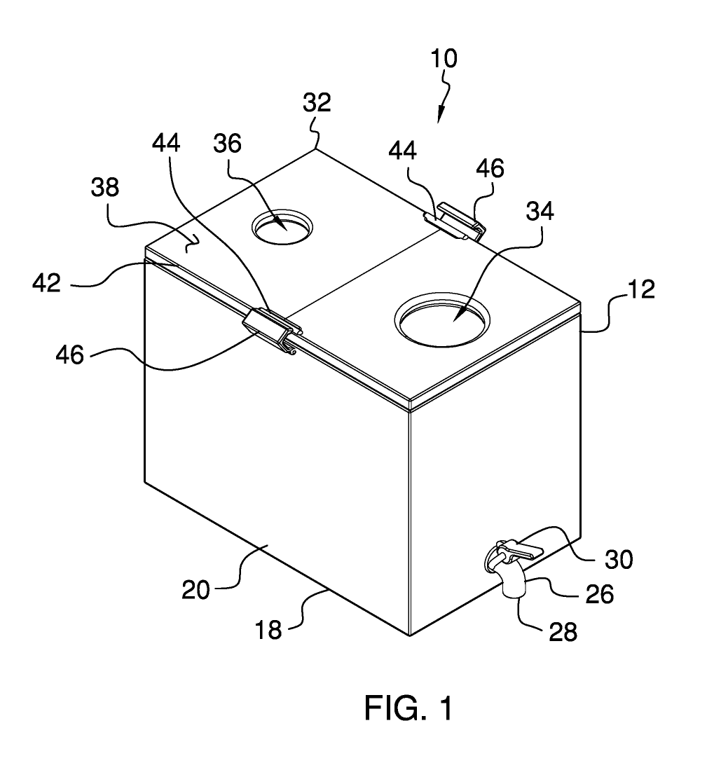

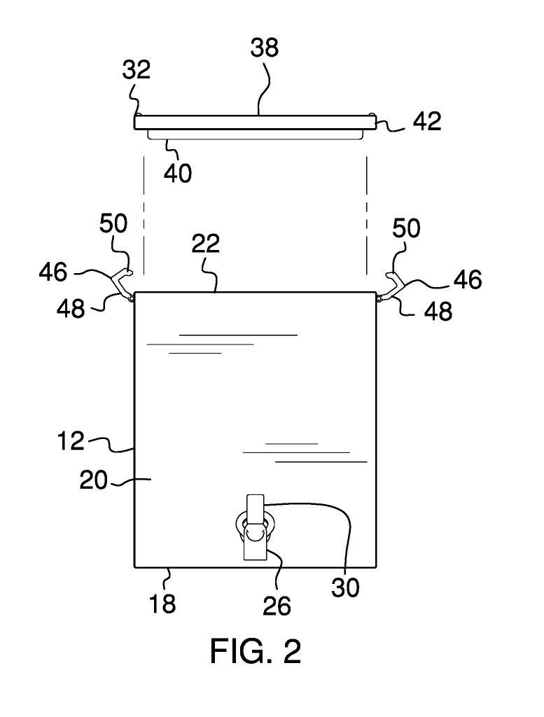

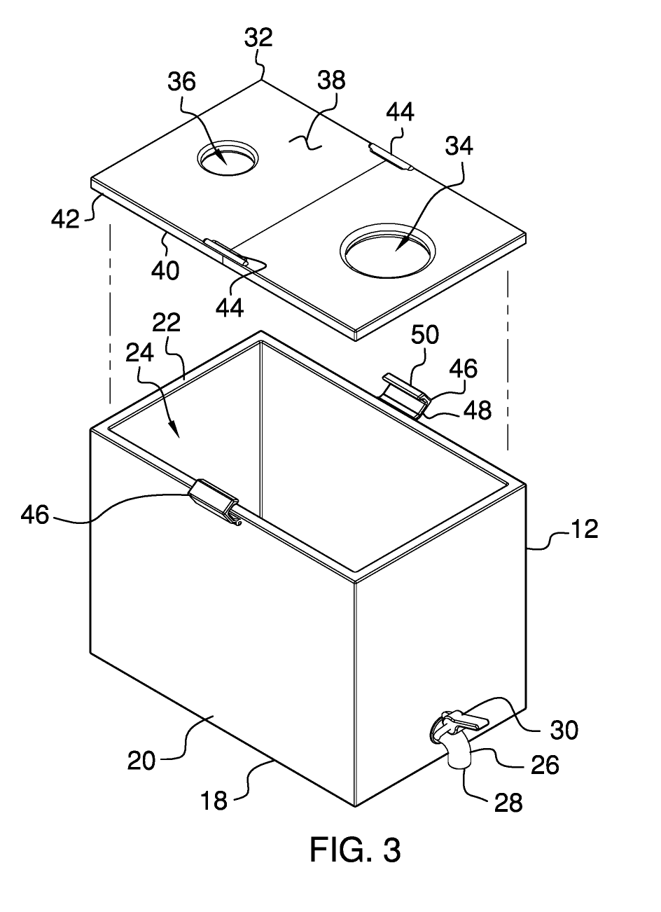

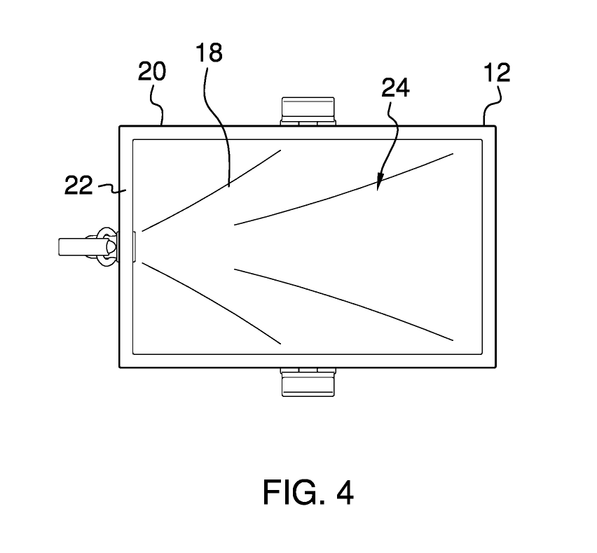

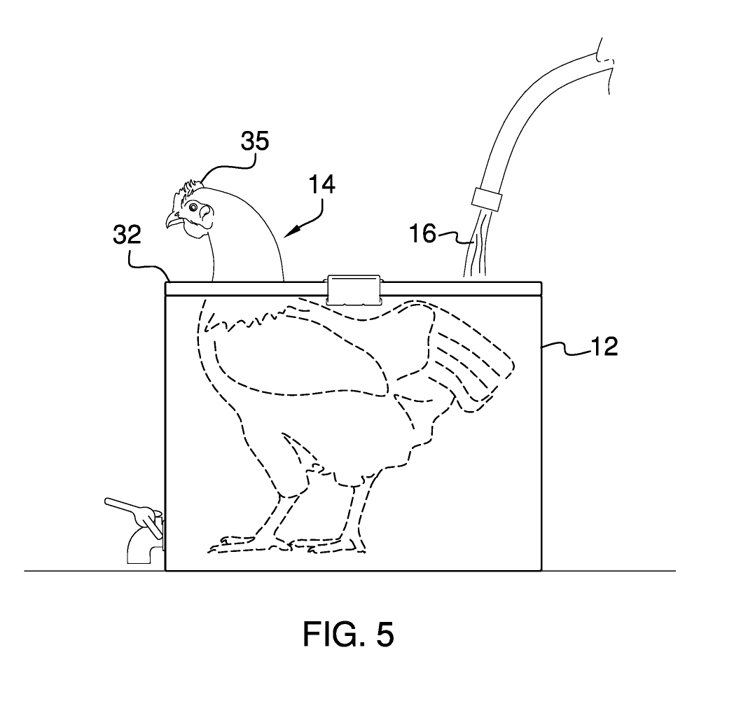

With reference now to the drawings, and in particular to FIGS. 1 through 5 thereof, a new bathing device embodying the principles and concepts of an embodiment of the disclosure and generally designated by the reference numeral 10 will be described.

As best illustrated in FIGS. 1 through 5, the animal bathing assembly 10 generally comprises a box 12 that may have an animal 14 positioned therein. A fluid 16 is selectively poured into the box 12 thereby facilitating the animal 14 to be bathed in the fluid 16. The fluid 16 may be heated water and the animal 14 may be a chicken or other bird. The box 12 has a bottom wall 18 and a perimeter wall 20 extending upwardly therefrom. The perimeter wall 20 has a distal edge 22 with respect to the bottom wall 18 defining an opening 24 into an interior of the box 12. The box 12 may have a length ranging between approximately 40.0 cm and 50.0 cm, a width ranging between approximately 30.0 cm and 35.0 cm and a height ranging between 30.0 cm and 35.0 cm. Moreover, the box 12 may be comprised of a thermally insulating material thereby facilitating the fluid 16 to retain heat in the box 12.

A spigot 26 is coupled to the box 12 to selectively drain the fluid 16 from the box 12. The spigot 26 is coupled to the perimeter wall 20 such that the spigot 26 is in fluid communication with the interior of the box 12. The spigot 26 has a distal end 28 with respect to the box 12 and the distal end 28 is open. The spigot 26 includes a valve 30 that may be manipulated. The valve 30 selectively opens and closes the spigot 26 to selectively restrict the fluid 16 from flowing through the spigot 26. The valve 30 may be a fluid valve of any conventional design.

A lid 32 is provided and the lid 32 is selectively positioned on the box 12. The lid 32 has a first opening 34 and have a head 35 of the animal 14 is extending therethrough when the lid 32 is positioned on the box 12. The lid 32 has a second opening 36 and the fluid 16 is poured through the second opening 36 when the lid 32 is positioned on the box 12. The lid 32 has a top surface 38, a bottom surface 40 and a perimeter edge 42 extending therebetween. Each of the first 34 and second 36 openings extends through the top 38 and bottom 40 surfaces and the first opening 34 is spaced from the second opening 36. The first opening 34 may have a diameter ranging between 10.0 cm and 15.0 cm thereby accommodating the animal's head 35. The second opening 36 may have a diameter that is less than the diameter of the first opening 34.

A pair of tabs 44 is provided and each of the tabs 44 is coupled to and extends upwardly from the top surface 38 of the lid 32. Each of the tabs 44 is aligned with the perimeter edge 42 of the lid 32 and the tabs 44 are positioned on opposite sides of the box 12 with respect to each other. A pair of locks 46 is provided and each of the locks 46 is hingedly coupled to the box 12. Each of the locks 46 is selectively manipulated to engage the lid 32 thereby removably retaining the lid 32 on the box 12. In this way the lid 32 inhibits the animal 14 from escaping the box 12.

Each of the locks 46 has a leg 48 and a foot 50. The leg 48 corresponding to each of the locks 46 is hingedly coupled to the perimeter wall 20 of the box 12 and each of the locks 46 is aligned with the distal edge 22 of the box 12. The foot 50 corresponding to each of the locks 46 frictionally engages an associated one of the tabs 44 on the lid 32 when each of the locks 46 is urged into a locked position. Thus, the lid 32 is retained on the box 12. The foot 50 corresponding to each of the locks 46 is spaced from the lid 32 when each of the locks 46 is urged into an unlocked position. Thus, the lid 32 is removable from the box 12.

In use, the animal 14 is positioned in the box 12 and the lid 32 is positioned on the box 12 having the animal's head 35 extending through the first opening 34. Each of the locks 46 is manipulated to secure the lid 32 on the box 12 and the fluid 16 is poured through the second opening 36. The animal 14 is retained in the fluid 16 for a selected amount of time thereby facilitating the animal 14 to be bathed. In this way the animal's 14 cleanliness and health are enhanced. Moreover, the box 12 retains the fluid 16 at a selected temperature thereby enhancing the animal 14's comfort when the animal 14 is bathed. The valve 30 is manipulated to drain the fluid 16 from the box 12 when the animal 14 is finished bathing. The each of the locks 46 is manipulated to unlock the lid 32, the lid 32 is removed from the box 12 and the animal 14 is removed from the box 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animal bathing assembly being configured to restrain an animal thereby facilitating the animal to be bathed, said assembly comprising:
a box being configured to have an animal positioned therein, said box being configured to be selectively filled with a fluid thereby facilitating the animal to be bathed in the fluid;
a spigot being coupled to said box wherein said spigot is configured to selectively drain the fluid from said box;
a lid being selectively positioned on said box, said lid having a first opening wherein said first opening is configured to have a head of the animal extending therethrough when said lid is positioned on said box, said lid having a second opening wherein said second opening is configured to have the fluid poured therethrough when said lid is positioned on said box; and
a pair of locks, each of said locks being hingedly coupled to said box wherein each of said locks is configured to be manipulated, each of said locks engaging said lid to removably retain said lid on said box wherein said lid is configured to inhibit the animal from escaping said box.

2. The assembly according to claim 1, wherein:
said box has a bottom wall and a perimeter wall extending upwardly therefrom, said perimeter wall having a distal edge with respect to said bottom wall defining an opening into an interior of said box; and
said spigot is coupled to said perimeter wall such that said spigot is in fluid communication with said interior of said box, said spigot having a distal end with respect to said box, said distal end being open, said spigot including a valve being configured to be manipulated, said valve selectively opening and closing said spigot wherein said valve is configured to selectively restrict the fluid from flowing through said spigot.

3. The assembly according to claim 1, wherein said lid has a top surface, a bottom surface and a perimeter edge extending therebetween, each of said first and second openings extending through said top and bottom surfaces, said first opening being spaced from said second opening.

4. The assembly according to claim 3, further comprising a pair of tabs, each of said tabs being coupled to and extending upwardly from said top surface of said lid, each of said tabs being aligned with said perimeter edge of said lid, said tabs being positioned on opposite sides of said box with respect to each other.

5. The assembly according to claim 2, wherein:
said lid includes a pair of tabs; and
each of said locks has a leg and a foot, said leg corresponding to each of said locks being hingedly coupled to said perimeter wall of said box, each of said locks being aligned with said distal edge of said box, said foot corresponding to each of said locks frictionally engaging an associated one of said tabs on said lid when each of said locks is urged into a locked position, said foot corresponding to each of said locks being spaced from said lid when each of said locks is urged into an unlocked position.

6. An animal bathing assembly being configured to restrain an animal thereby facilitating the animal to be bathed, said assembly comprising:
a box being configured to have an animal positioned therein, said box being configured to be selectively filled with a fluid thereby facilitating the animal to be bathed in the fluid, said box having a bottom wall and a perimeter wall extending upwardly therefrom, said perimeter wall having a distal edge with respect to said bottom wall defining an opening into an interior of said box;
a spigot being coupled to said box wherein said spigot is configured to selectively drain the fluid from said box, said spigot being coupled to said perimeter wall such that said spigot is in fluid communication with said interior of said box, said spigot having a distal end with respect to said box, said distal end being open, said spigot including a valve being configured to be manipulated, said valve selectively opening and closing said spigot wherein said valve is configured to selectively restrict the fluid from flowing through said spigot;
a lid being selectively positioned on said box, said lid having a first opening wherein said first opening is configured to have a head of the animal extending therethrough when said lid is positioned on said box, said lid having a second opening wherein said second opening is configured to have the fluid poured therethrough when said lid is positioned on said box, said lid having a top surface, a bottom surface and a perimeter edge extending therebetween, each of said first and second openings extending through said top and bottom surfaces, said first opening being spaced from said second opening;
a pair of tabs, each of said tabs being coupled to and extending upwardly from said top surface of said lid, each of said tabs being aligned with said perimeter edge of said lid, said tabs being positioned on opposite sides of said box with respect to each other; and
a pair of locks, each of said locks being hingedly coupled to said box wherein each of said locks is configured to be manipulated, each of said locks engaging said lid to removably retain said lid on said box wherein said lid is configured to inhibit the animal from escaping said box, each of said locks having a leg and a foot, said leg corresponding to each of said locks being hingedly coupled to said perimeter wall of said box, each of said locks being aligned with said distal edge of said box, said foot corresponding to each of said locks frictionally engaging an associated one of said tabs on said lid when each of said locks is urged into a locked position, said foot corresponding to each of said locks being spaced from said lid when each of said locks is urged into an unlocked position.
